(19) United States
(12) Patent Application Publication
(10) Pub. No.: US 2024/0246729 A1
(43) Pub. Date: Jul. 25, 2024

(54) CONTAINER COMPRISING FIBERS, HAVING A CONTAINER BODY COMPRISING FIBERS AND A LID COMPRISING FIBERS, LID COMPRISING FIBERS, METHOD FOR PRODUCING THE CONTAINER, DEVICE FOR CARRYING OUT THE METHOD, METHOD FOR PRODUCING THE LID

(71) Applicant: Krones AG, Neutraubling (DE)

(72) Inventors: Andreas HIPPEL, Wörth (DE); Jörg ZACHARIAS, Köfering (DE)

(21) Appl. No.: 18/419,072

(22) Filed: Jan. 22, 2024

(30) Foreign Application Priority Data
Jan. 24, 2023 (DE) 102023101648.2

(51) Int. Cl. B65D 39/00; B65D 1/02; B65D 65/46; D21J 1/08; D21J 3/10

(52) U.S. Cl. CPC B65D 39/0005; B65D 1/0207; B65D 65/466; D21J 1/08; D21J 3/10

(57) ABSTRACT

The disclosure relates to a container comprising fibers, the container having: a container body comprising fibers, the container body having a mouth region which surrounds a mouth opening; and a lid comprising fibers, the lid having a circumferential groove. In a closure position, at least one part of the mouth region is accommodated in the groove, and the container body is thereby closed. The lid is designed to be moved from the closure position into an open position away from the container body. The disclosure also relates to a lid comprising fibers, the lid having a circumferential groove, for use for the container comprising fibers, to a method for producing a container comprising fibers, to a device for carrying out the method for producing a container comprising fibers, and to a method for producing a lid comprising fibers.

### CROSS REFERENCE TO RELATED APPLICATION

The present application claims priority to German Patent Application No. 10 2023 101 648.2 filed on Jan. 24, 2023. The entire contents of the above-listed application are hereby incorporated by reference for all purposes.

### TECHNICAL FIELD

The disclosure relates to a container comprising fibers, having a container body comprising fibers and a lid comprising fibers, to a lid comprising fibers for use for the container comprising fibers, to a method for producing a container comprising fibers, to a device for carrying out the method for producing a container comprising fibers, and to a method for producing a lid comprising fibers.

### BACKGROUND

It is known to equip containers comprising fibers with a plastic thread and plastic lids in order to be able to ensure reclosability of such a container. Reclosability of containers can be desirable in particular in the case of filling quantities of more than 200 mL, since this quantity is generally not emptied in one go. Due to the different materials, the container is not compostable and is also difficult to recycle.

### SUMMARY

### Object

The object of the disclosure is to provide a container comprising fibers, having a container body comprising fibers and a lid comprising fibers, a lid comprising fibers for use for the container comprising fibers, a method for producing a container comprising fibers, a device for carrying out the method for producing a container comprising fibers, and a method for producing a lid comprising fibers, such that the aforementioned can enable a container body comprising fibers to be closable and reclosable without the provision of a screw thread.

### Achievement

The object is achieved by the container comprising fibers, having a container body comprising fibers and a lid comprising fibers, the lid comprising fibers for use for the container comprising fibers, the method for producing a container comprising fibers, the device for carrying out the method for producing a container comprising fibers, and the method for producing a lid comprising fibers.

The disclosure provides a container comprising fibers, having: a container body comprising fibers, the container body having a mouth region which surrounds a mouth opening; and a lid comprising fibers, the lid having a circumferential groove; wherein, in a closure position, at least one part of the mouth region is accommodated in the groove, and the container body is thereby closed, and wherein the lid is designed to be moved from the closure position into an open position away from the container body.

Since both the container body and the lid comprise fibers, the container can be biodegradable and/or compostable.

An open position away from the container body can mean that the lid can be removed completely from the at least one part of the mouth region which is received by the groove.

The lid can be a reclosable lid. The lid can be moved from the closed position into an open position and can be moved from this open position back into the closed position. These operations can be repeated.

The fibers may comprise lignin, banana leaves, and/or wild quinine. The fibers may, for example, comprise cellulose fibers, fibers of conifers, leafy woody plants, and/or plane trees and/or grasses, reeds and/or bamboo or the like. The fibers may comprise silk threads, spider silk, algae, natural fibers (such as Danube silphie fibers, hemp, maize, cotton), banana peel, orange peel, grass, straw, potato starch, or processed cow dung. It is also possible to provide cellulose fibers which originate from a process by which they were artificially grown. In the event of material bottlenecks of wood as the basic material for a fluid mass with fibers, these alternative materials can completely or partially replace the basic material.

The fibers can comprise fiber mixtures made of non-wood material—for example, cotton, hemp, and/or textile fibers.

For example, the fibers may comprise viscose fibers. A viscose fiber is an artificial fiber made of regenerated cellulose, wherein the viscose fibers have, as starting base, 100% cellulose treated in a multi-stage process. The viscose fibers may comprise a flat or cable-shaped structure, a trilobal shape, or a double trilobal structure. The fibers may comprise a flat or hollow structure or a corrugated or rough outer surface.

Various types of fibers may also be used in combination. For example, fibers with different outer surfaces, lengths, and/or shapes and/or hollow structure and/or flat structure and/or of different materials may be combined.

Due to the natural origin of the fibers, they may be biodegradable. In addition, they are sustainable and renewable.

The fibers may be used in a pulp. The pulp may be or comprise a mixture of water, e.g., with additives, and fibers.

The container may be a bottle or a can.

The molding of the container comprising fibers and/or of the lid comprising fibers, by the use of the fiber-containing pulp, can be carried out in a mold provided for this purpose, which can be a negative mold of an outer contour of the container body to be produced or a negative mold of an outer contour of the lid to be produced, or said molding can be carried out by means of an injection-molding method.

The fiber-containing pulp that is used for molding the container body comprising fibers and the fiber-containing pulp that is used for molding the lid comprising fibers can be the same or different.

For example, the lid comprising the fibers can be produced from a thicker and/or stiffer material than the container body in order to achieve a necessary stability.

In the closure position, the at least one part of the mouth region can be held with form-locking and/or force-locking and/or frictional-locking.

It can also be possible that the lid comprising the fibers can be held in the closure position solely by latching, or by latching and with form-locking and/or force-locking and/or frictional-locking. The latching can be achieved by virtue of the fact that a first cross-section of the at least one part of the mouth cross-section and a second cross-section of the groove can be designed correspondingly, as described further above or further below.

When the closure is being moved into the closure position, i.e., for example, when pressing is being performed, a force can be exerted on the lid, e.g., on a lid region away from the groove, towards the mouth opening. In the process, the lid can be pressed in towards the mouth opening, so that an air volume can be pressed out of the container body comprising fibers. As a result, the lid can be under stress, which can assist and/or help the lid to stay in the closure position.

The holding with form-locking and/or force-locking and/or frictional-locking can be achieved, for example, by the corresponding shaping of a cross-section of the groove of the lid and of the at least one part of the mouth region.

For example, the cross-section of the groove be designed to be bulbous on both sides and the cross-section of the at least one part of the mouth region rectangular, so that the bulbous portions of the groove can press the at least one part of the mouth region between them with different intensity.

For example, the cross-section of the groove can be designed to be bulbous on both sides and the cross-section of the at least one part of the mouth region depressed on both sides, so that the bulbous portions of the groove can extend into the depressed regions of the at least one part of the mouth region. As the lid is being pressed onto the at least one part of the mouth region, overcoming a press-on force can be required.

For example, the cross-section of the groove can be depressed on both sides, and the cross-section of the at least one part of the mouth region can be bulbous on both sides, so that the bulbous portions of the at least one part of the mouth region can extend into the depressed regions of the groove. As the lid is being pressed onto the at least one part of the mouth region, overcoming a press-on force can be required.

The container body can have been produced from a first fiber-containing pulp, and the lid can have been produced from a second fiber-containing pulp. For example, the first and second fiber-containing pulps can be the same or different.

At least surfaces of the lid that can come into contact with a product present in the container body can have a coating. For example, the coating can be food-safe and/or biodegradable and/or compostable and/or liquid-resistant.

The coating can protect the lid from softening due to absorbed product, the product can be protected from a change in taste due to the lid, and/or the sealing tightness of the lid in the closure position can be supported and/or ensured.

The lid can be designed such that it can be moved into the closure position by being pressed onto the at least one part of the mouth region. For example, the lid can be designed such that a first lid region away from the groove can be more reversibly deformable than a second lid region of the groove can be deformable.

For the pressing, the groove of the lid and the at least one part of the mouth region of the container body can be arranged in alignment or at least approximately in alignment with one another. The groove can then be pressed onto the at least one part of the mouth region by the pressing, and, in the closure position, the at least one part of the mouth region can be accommodated in the groove.

An outer surface of the lid, which outer surface can be arranged opposite the mouth opening, can be formed to be flat.

The mouth region can comprise a circumferential seam, which can be at least partly receivable by the groove. A type of tongue-and-groove connection between the lid and the container body can thus be achieved.

A contact surface of the lid and of the mouth region can have a sealing material at least in part. For example, the sealing material can comprise wax, adhesive, or sealing lacquer. For example, the sealing material can be food-safe and/or biodegradable and/or compostable.

The sealing material can reinforce the sealing tightness of the lid in the closure position, which can be useful, for example, in transport processes from a filling plant to the end consumer. When the lid is first moved from the closure position into an open position, a seal formed by the sealing material can be destroyed.

A sealing material can be provided on an outer surface of the mouth region towards the lid. For example, the sealing material can constitute a connection that can be destroyed during the movement from the closure position to the open position. For example, the sealing material can comprise wax, adhesive, or sealing lacquer. For example, the sealing material can be food-safe and/or biodegradable and/or compostable.

A seal which can be formed by the sealing material can additionally protect product in the container body from external influences. In addition, when it is intact, the seal can indicate, for example, that the container has not yet been opened since a filling process, i.e., that the lid has not yet been moved from a closure position, which it assumed after the filling process, into an open position. The sealing material can constitute a connection that can be destroyed during the movement from the closure position into the open position.

A first cross-section of the at least one part of the mouth cross-section can be rectangular, or bulbous on one side or on both sides, or depressed on one side or on both sides, wherein a second cross-section of the groove can be rectangular, or bulbous on one side or on both sides, or depressed on one side or on both sides, wherein the first and second cross-sections can be designed such that the at least one part of the mouth region can be holdable in the groove with form-locking and/or force-locking and/or frictional-locking and/or by latching.

A lid comprising fibers, said lid having a circumferential groove, for use for the container comprising fibers, as described above or further below, is provided.

The lid comprising fibers can comprise the features mentioned further above or further below in connection with the lid.

A method for producing a container comprising fibers, as described above or further below, is provided, wherein the container has: a container body comprising fibers, the container body having a mouth region which surrounds a mouth opening; and a lid comprising fibers, the lid having a circumferential groove. At least one part of the mouth region can be received in the closure position by the groove, wherein the at least one part of the mouth region is held in the groove with form-locking and/or force-locking and/or frictional-locking, wherein the method comprises closing the container body by means of the lid.

A first fiber-containing pulp can be used for the container body, and a second fiber-containing pulp can be used for the lid. For example, the first and second fiber-containing pulps can be the same or different. The first or second fiber-containing pulp can comprise the features which are mentioned further above or further below in connection with pulp in general, or in connection with the first pulp and the second pulp in particular.

The method can also comprise forming a first cross-section of the at least one part of the mouth cross-section, wherein the first cross-section can be rectangular, or bulbous on one side or on both sides, and can also comprise forming a second cross-section of the groove, wherein the second cross-section can be rectangular, or bulbous on one side or on both sides. The first and second cross-sections can be designed such that the at least one part of the mouth region can be holdable in the groove with form-locking and/or force-locking and/or frictional-locking.

The method can also comprise flatly forming an outer surface of the lid, which outer surface can be arranged opposite the mouth opening, and/or providing a circumferential seam at the mouth region, which seam can be at least partially receivable by the groove.

The method can also comprise providing a coating on at least such surfaces of the lid as can come into contact with a product which can be provided in the container body. For example, the coating can be food-safe and/or biodegradable and/or compostable and/or liquid-resistant.

In addition, a device for carrying out the method for producing a container comprising fibers, as described above or further below, is provided.

Furthermore, a method for producing a lid comprising fibers, as described above or further below, is provided.

### BRIEF DESCRIPTION OF FIGURES

The accompanying figures show, by way of example, aspects and/or exemplary embodiments of the disclosure for better understanding and illustration. In the figures:

FIG. 1 shows a cross-section of a container with container body and lid in a closure position,

FIG. 2 shows a cross-section of a mouth region with lid in a closure position, and

FIG. 3 shows a cross-section of a mouth region with lid in an open position.

### DETAILED DESCRIPTION OF FIGURES

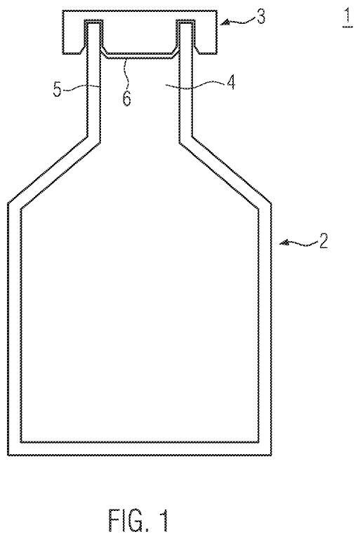

FIG. 1 shows a cross-section of a container 1 comprising fibers, with a container body 2 comprising fibers and a lid 3 comprising fibers in a closure position. The container body 2 comprises a mouth region 5 which surrounds a mouth opening 4. In the closure position, at least one part of the mouth region (5) is accommodated in a groove 10 of the lid 3, and the container body 2 is thereby closed. The lid 3 has a coating 6 on a surface that could come into contact with a product present in the container body 2. The coating 6 can be food-safe and/or biodegradable and/or compostable and/or liquid-resistant.

The lid 3 is designed to be moved from the closure position shown into an open position (see FIG. 3) away from the container body 2. To close the container body 2 again, the lid 3 can be moved back into the closure position.

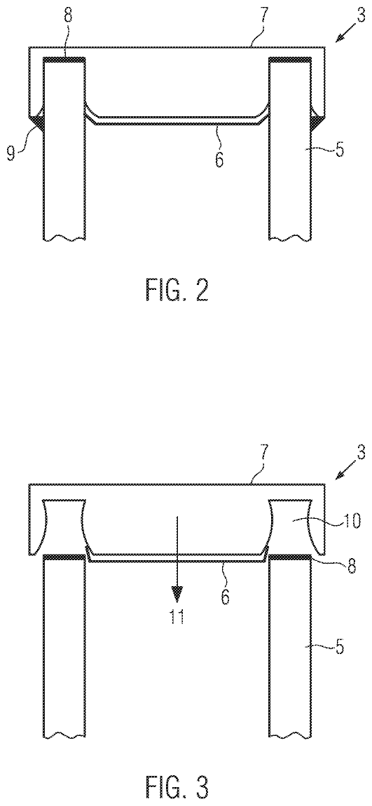

FIG. 2 shows a cross-section of the mouth region 5 with the lid 3 comprising fibers in the closure position. It can be seen that the coating 6 of the lid 3 also at least partly nestles internally against an inner surface of the mouth region 5, so that product present in the container body 2 can be prevented from contacting the lid 3. As a result, the lid 3 can be protected, for example, from softening due to absorbed product, the product can be protected from a change in taste due to the lid, and/or the sealing tightness of the lid 3 in the closure position can be supported and/or ensured.

A contact surface of the lid 3 and of the mouth region 5 has, in the representation, a first sealing material 8, at least in part. The first sealing material 8 can reinforce in the closure position the sealing tightness of the lid 3, which can be useful, for example, in transport processes from a filling plant to the end consumer. When the lid 3 is first moved from the closure position into an open position, a first seal formed by the first sealing material can be destroyed. The first sealing material 8 can comprise wax, adhesive, and/or sealing lacquer, wherein, for example, the first sealing material 8 can be food-safe and/or biodegradable and/or compostable.

A second sealing material 9 be provided on an outer surface of the mouth region 5 towards the lid 3. A second seal, which can be formed by the second sealing material 9, can additionally protect product in the container body 2 from external influences. In addition, when it is intact, the second seal can indicate, for example, that the container has not yet been opened since a filling process, i.e., that the lid 3 has not yet been moved from a closure position, which it assumed after the filling process, into an open position. The second sealing material 9 can constitute a connection that can be destroyed during the movement from the closure position into the open position. The second sealing material 9 can comprise wax, adhesive, and/or sealing lacquer, wherein, for example, the second sealing material 9 can be food-safe and/or biodegradable and/or compostable.

FIG. 3 shows a cross-section of the mouth region 5 with the lid 3 in an open position. The circumferential groove 10 of the lid 3 can be seen here, said groove having a first cross-section which is bulbous on both sides. The second cross-section of the at least one part of the mouth region 5 which is accommodated in the closure position in the groove 10 is rectangular.

The first and second cross-sections are designed such that, in the closure position, the at least one part of the mouth region 5 can be held in the groove 10 with form-locking and/or force-locking and/or frictional-locking.

In the open position, the first sealing material 8 on the contact surface of the lid 3 and of the mouth region 5 is still present. The second sealing material on the outer surface of the mouth region 5 towards the lid 3 was destroyed when the lid 3 was moved from the closure position into the open position.

In order to move the lid 3 from the shown open position back into a closure position, the lid 3 can be moved into the closure position by a pressing of the groove 10 in a direction 11 onto the at least one part of the mouth region 5 and can thereby close the container body 2.

1. Container comprising fibers, the container having: a container body comprising fibers, the container body having a mouth region which surrounds a mouth opening; and a lid comprising fibers, the lid having a circumferential groove; wherein, in a closure position, at least one part of the mouth region is accommodated in the groove, and the container body is thereby closed, and wherein the lid is designed to be moved from the closure position into an open position away from the container body.

2. Container according to claim 1, wherein, in the closure position, the at least one part of the mouth region is held with form-locking and/or force-locking and/or frictional-locking.

3. Container according to claim 1, wherein the container body has been produced from a first fiber-containing pulp, and the lid has been produced from a second fiber-containing pulp, and wherein, for example, the first and second fiber-containing pulps are the same or different.

4. Container according to claim 3, wherein at least surfaces of the lid that can come into contact with a product present in the container body have a coating, and wherein, for example, the coating is food-safe and/or biodegradable and/or compostable and/or liquid-resistant.

5. Container according to claim 4, wherein the lid is designed such that it can be moved into the closure position by being pressed onto the at least one part of the mouth region, and wherein, for example, the lid is designed such that a first lid region away from the groove is more reversibly deformable than a second lid region of the groove is deformable.

6. Container according to claim 5, wherein an outer surface of the lid, which outer surface is arranged opposite the mouth opening, is flat.

7. Container according to claim 6, wherein the mouth region comprises a circumferential seam, which can be at least partially received by the groove.

8. Container according to claim 7, wherein a contact surface of the lid and of the mouth region has a sealing material at least in part, wherein, for example, the sealing material comprises wax, adhesive, and/or sealing lacquer, and wherein, for example, the sealing material is food-safe and/or biodegradable and/or compostable.

9. Container according to claim 8, wherein a sealing material is provided on an outer surface of the mouth region towards the lid, wherein, for example, the sealing material constitutes a connection that can be destroyed during movement from the closure position into the open position, wherein, for example, the sealing material comprises wax, adhesive, and/or sealing lacquer, and wherein, for example, the sealing material is food-safe and/or biodegradable and/or compostable.

10. Container according to claim 9, wherein a first cross-section of the at least one part of the mouth region is rectangular or is bulbous on one side or on both sides or is depressed on one side or on both sides, wherein a second cross-section of the groove is rectangular or is bulbous on one side or on both sides or is depressed on one side or on both sides, and wherein the first and second cross-sections can be designed such that the at least one part of the mouth region is holdable in the groove with form-locking and/or force-locking and/or frictional-locking and/or by latching.

11. Lid comprising fibers, the lid having a circumferential groove, for use for the container comprising fibers according to claim 1.

12. Method for producing a container comprising fibers according to claim 1, wherein the container has: a container body comprising fibers, the container body having a mouth region which surrounds a mouth opening; and a lid comprising fibers, the lid having a circumferential groove; wherein at least one part of the mouth region can be accommodated in the closure position in the groove, wherein the at least one part of the mouth region is held in the groove with form-locking and/or force-locking and/or frictional-locking, and wherein the method comprises closing the container body by means of the lid.

13. Method according to claim 12, wherein a first fiber-containing pulp is used for the container body and a second fiber-containing pulp is used for the lid, and wherein, for example, the first and second fiber-containing pulps are the same or different.

14. Method according to claim 12, further comprising forming a first cross-section of the at least one part of the mouth region, wherein the first cross-section is rectangular or bulbous on one side or on both sides, and forming a second cross-section of the groove, wherein the second cross-section is rectangular or is bulbous on one side or both sides, wherein the first and second cross-sections are designed such that the at least one part of the mouth region can be held in the groove with form-locking and/or force-locking and/or frictional-locking.

15. Method according to claim 12, further comprising:
flatly forming an outer surface of the lid, which outer surface is arranged opposite the mouth opening, and/or
providing a circumferential seam at the mouth region, which seam can be at least partly received by the groove.

16. Method according to claim 12, further comprising:
providing a coating on at least such surfaces of the lid as can come into contact with a product which can be provided in the container body, wherein, for example, the coating is food-grade and/or biodegradable and/or compostable and/or liquid-resistant.

17. Device for carrying out the method according to claim 12.

18. Method for producing the lid comprising fibers according to claim 11.
